(19) United States
(12) Patent Application Publication
(10) Pub. No.: US 2014/0344857 A1
(43) Pub. Date: Nov. 20, 2014

(54) User Interface for Video Delivery System with Program Guide Overlay

(71) Applicant: Aereo, Inc., New York, NY (US)

(72) Inventors: Chaitanya Kanojia, West Newton, MA (US); William Griffin Cherry, Roslindale, MA (US)

(21) Appl. No.: 14/279,494

(22) Filed: May 16, 2014

Related U.S. Application Data
(60) Provisional application No. 61/824,673, filed on May 17, 2013.

(51) Int. Cl. H04N 21/482

(52) U.S. Cl. CPC H04N 21/482
USPC 725/39

(57) ABSTRACT

A graphical user interface implemented on user devices and method for displaying a program guide is disclosed. Upon invocation of a program guide from an active area tab, a program guide overlay is displayed over a video portion of the graphical user interface. Additionally, when the program guide overlay is displayed, a volume of the video portion is lowered or muted and a video portion of the graphical user interface is grayed out.

### RELATED APPLICATIONS

This application claims the benefit under 35 USC 119(e) of U.S. Provisional Application No. 61/824,673, filed on May 17, 2013, which is incorporated herein by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

In general, cloud based video delivery systems provide content such as television programs, movies, or user generated video to users via data networks such the Internet and/or private networks such as cable service provider or cellular data networks. Users typically access the cloud systems by invoking dedicated applications on their user devices or using general purpose browsers to navigate to websites of the cloud systems. After invoking the applications or navigating to the websites, graphical user interfaces (GUI) are displayed on the user devices that enable the users to access the various content.

Currently, well-known cloud based video delivery systems are provided by companies such as HULU, LLC, Netflix, Inc., and YouTube, LLC, to list a few examples. While there is often overlap in the content provided by the different systems, they generally serve different consumer needs. HULU, LLC, for example, typically offers recently aired television programs after those programs have been first broadcast by broadcasting entities such as the major television networks. Netflix, Inc. offers its users access to movies, television programs, and documentaries, for example, that have been released on DVD as well as content created specifically for Netflix, Inc. and/or Internet broadcast (webisodes). Lastly, the YouTube, LLC website allows users to view and share user-generated content such as home movies, video logs (video blogs or vlog), and instructional videos to list a few examples.

Recently, a cloud based video delivery system has been developed that permits users to capture over the air broadcast content from the broadcasting entities such as the major television networks. Upon receiving a request from a subscribing user, this cloud based video delivery system tunes a specific user-assigned antenna element to capture the over the air content broadcast by the broadcasting entities. The captured content is then decoded and stored by the cloud system or streamed to the user devices of that user.

### SUMMARY OF THE INVENTION

While graphical user interfaces generally enable navigation of the cloud-based video delivery systems, there are some problems with the current interfaces. For example, when menus or program guides are selected by users while streaming content is playing on the users' devices, the content will continue playing while the menu or guide is displayed. This is distracting to the users as they try to find new television programs, for example. Likewise, noises from the streaming content (e.g., gun fire or explosions in action sequences), loud music, or dialogue between characters can also make it difficult for the users to concentrate when trying to select new programs. Nevertheless, users want some ability to monitor the streaming content if they decide to switch-back and not select a new program.

Another problem with some interfaces is that accessing a menu or guide causes the streaming content to stop playing completely. In this scenario, users are forced to wait for their streaming content to buffer and begin streaming whenever they want to view a menu or guide. This stopping and starting is frustrating for the users that want to search for new content on other channels.

The present system concerns a graphical user interface (or GUI) that provides for the overlaying of menus or guides in the GUI. Upon selection of a menu, the volume of the streaming content is lowered and the video content is sent to the background of the GUI and grayed out. Graying out reduces the contrast, brightness, and/or color saturation of the streaming content to give it a gray appearance and/or make it less evident. The lowering of the volume and/or the graying out of streaming content reduces possible distractions from the streaming content, but still allows the users to monitor what is happening in the television programs.

After the users select a new television program or choose to exit the program guide, the guide disappears (or returns to an active area) and the volume and colors of the streaming content are returned to previous levels.

In general, according to one aspect, the invention features a graphical user interface in a cloud based video delivery system. The system includes a video portion in which video content is displayed and a program guide overlay that is displayed over the video portion when invoked.

In embodiments, an active area is displayed adjacent to the video portion, wherein upon selection of the active area, the overlay is displayed over the video portion. Typically, the video portion displays pre-recorded or live broadcast television programs and when the program guide overlay is invoked, a volume of the video content is reduced or muted.

Preferably, the overlay, which is displayed over the video portion, is partially transparent to allow viewing of the video content through the overlay. The video content behind the overlay can be grayed out and/or blurred when the overlay is invoked.

In general, according to another aspect, the invention features a method for displaying a program guide in a graphical user interface. The method includes displaying video content in a video portion of the graphical user interface and displaying a program guide overlay over the video portion of the graphical user interface in response to an invocation of the program guide.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram illustrating the relationship between broadcasting entities, antenna elements, a cloud based video delivery system, and user devices.

FIG. 2 is a block diagram illustrating an example of system architecture implemented on one of the user devices.

FIG. 3 shows an example of a graphical user interface that includes a featured programming section and an active section.

FIG. 4 illustrates an example of the graphical user interface, which includes a video portion displaying streaming content.

FIG. 5A shows an example of a program guide, which is displayed over the video portion in the graphical user interface.

FIG. 5B shows an alternative embodiment of the program guide that is partially transparent.

FIG. 5C shows an alternative embodiment of the program guide that is partially transparent and the video is blurred.

FIG. 6 is a flowchart illustrating the steps for displaying the program guide over the video portion and lowering the volume of video content.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms of the articles/nouns “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

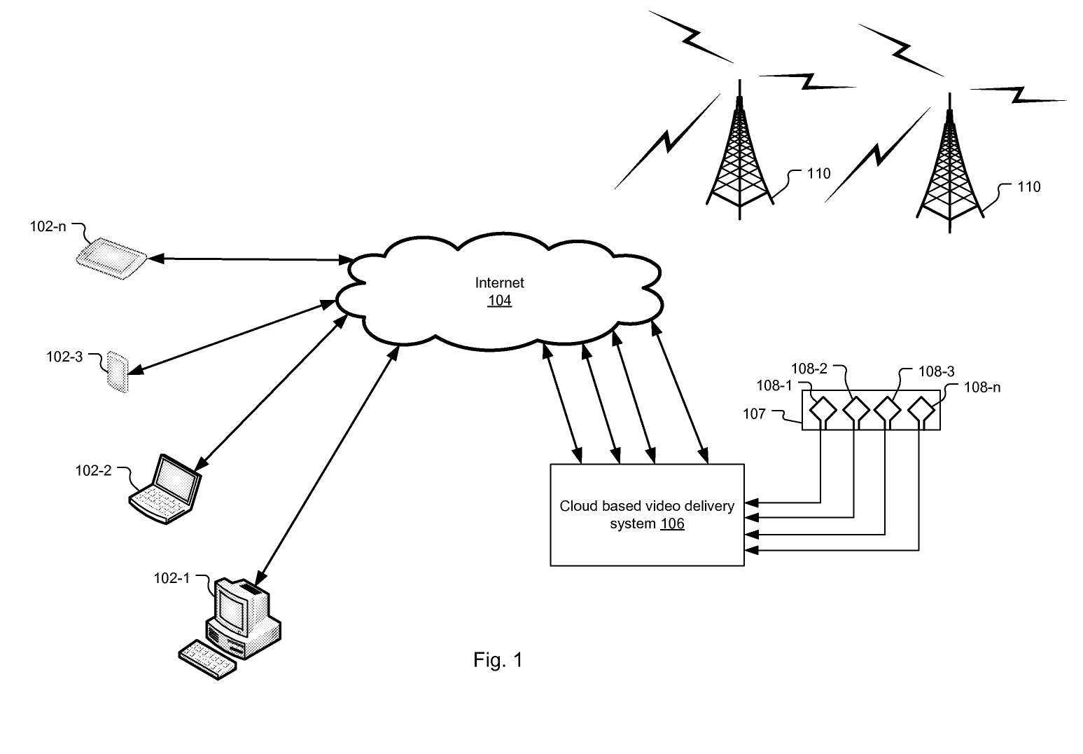

FIG. 1 is a block diagram illustrating the relationship between broadcasting entities 110, a cloud based video delivery system 106, and user devices 102-1 to 102-n.

In one implementation, different over the air content, such as television programs, are broadcast by broadcasting entities (or networks) 110 and captured by antenna elements 108-1 to 108-n in an antenna array 107 of the cloud based video delivery system 106. Based on requests from users, the captured over the air content is decoded and stored and/or streamed to the user devices 102-1 to 102-n. An example of a system for capturing and streaming over the air content to users is described in “System and Method for Providing Network Access to Antenna Feeds” by Kanojia et al., filed Nov. 17, 2011, U.S. patent application Ser. No. 13/299,186 (U.S. Patent Application Publication Number: US 2012/0127374 A1), which is incorporated herein by reference in its entirety.

The antenna elements 108-1 to 108-n are installed in antenna arrays 107 and are separately tunable for capturing over the air content from the same or different broadcasting entities under the control of the users. Some examples of common broadcasting entities include The American Broadcasting Company (ABC), The National Broadcasting Company (NBC), FOX broadcasting company, and CBS broadcasting corporation (CBS).

The user devices 102-1 to 102-n typically include personal computers such as laptop and desktop computers, tablets (or slate) computing devices such as the iPad mobile computing device by Apple Inc., or smartphones (e.g., iPhone mobile computing device by Apple Inc. or devices running the Android operating system by Google Inc.). Additionally, many modern game consoles, DVD players, and televisions are able to connect to the Internet and provide web browsing capabilities.

The user devices 102-1 to 102-n connect to the cloud based video delivery system 106 via the Internet 104, mobile data networks, cellular phone networks, access provider networks, enterprise networks, and/or other public and private data networks.

In a preferred embodiment, the cloud based video delivery system 106 provides live and/or pre-recorded broadcast television programs that are captured by the antenna elements 108-1 to 108-n to the users.

In alternative embodiments, however, the cloud based video delivery system 106 also or in the alternative streams purchased content, user-generated content, or Internet-based television shows (e.g., webisodes). In still other alternative embodiments, the cloud based video delivery system 106 does not stream live and/or pre-recorded broadcast television programs, but only functions as a content distribution system for content that is stored in the system or accessed by it.

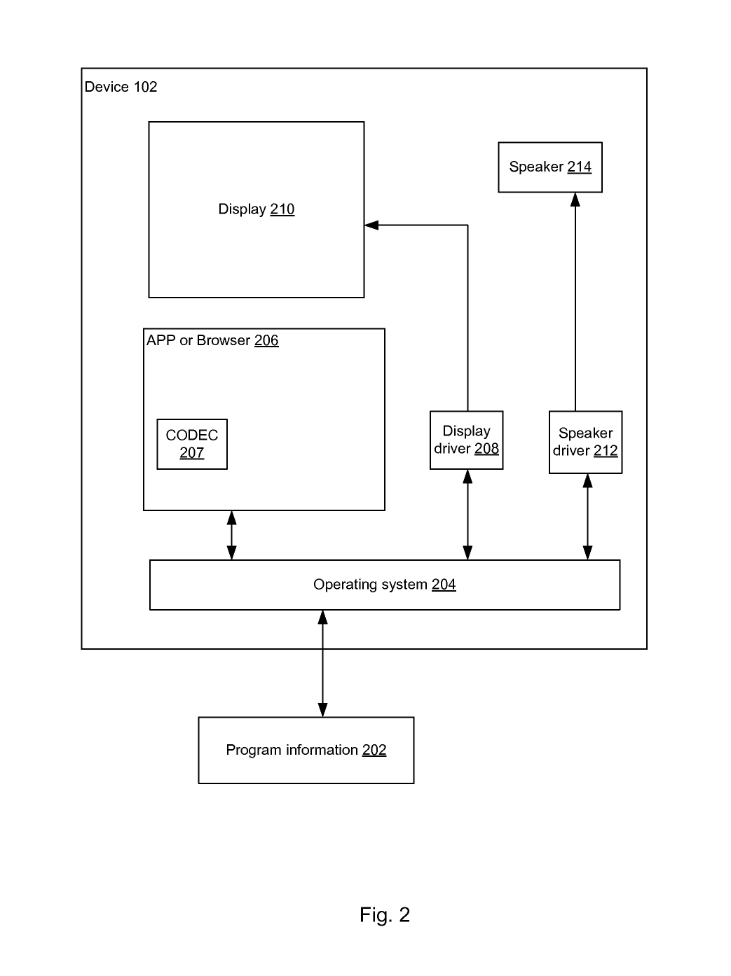

FIG. 2 is a block diagram illustrating an example of system architecture implemented on one of the user devices 102.

Generally, operating systems are divided into an application space and a kernel. The application space is reserved for executing applications and programs, whereas the kernel manages hardware, system memory, and low level processes of the user device 102.

For example, the operating system 204 maintains the data connection to the cloud based video delivery system 106 so that program information 202 is received and passed to an application (App) or browser 206. This program information includes both the encoded content and other information, such as menus or guides, that are to be displayed to the user. The application (App) or browser 206 accesses or includes a coder-decoder (CODEC) 207 that decodes (or encodes) audio and/or video data of the content in the program information 202. The decoded audio data are then sent via the operating system 204 to a speaker driver 212. Similarly, the decoded video data are sent via the operating system 204 to a display driver 208. The display driver 208 and speaker driver 212 then control the display 210 and speaker 214, respectively.

The user devices typically include many additional applications, device drivers, and/or hardware components on which these software components execute. For example, the user devices generally also include a central processing unit on which the applications and operating system execute, memory (e.g., RAM), storage systems, and network interface controllers. Likewise, human controlled interfaces (e.g., keyboard, mouse, touchscreen, remote control device and/or stylus) are used to control the device 102.

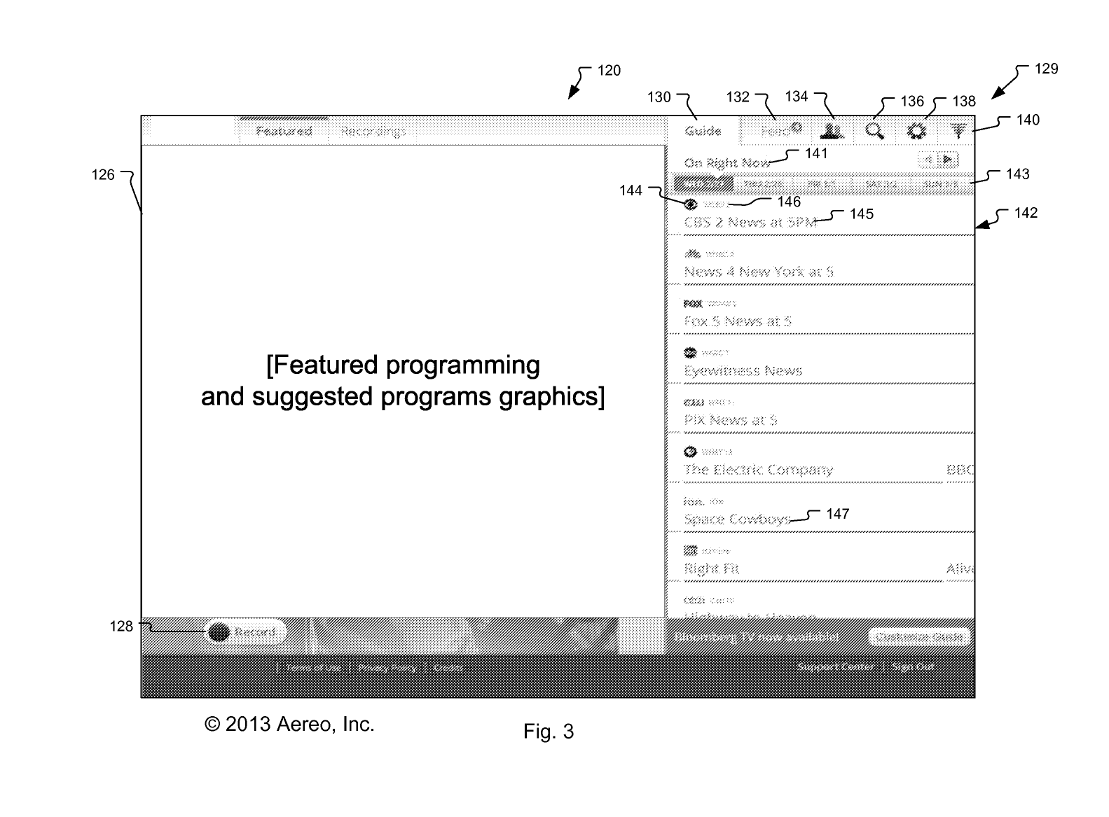

FIG. 3 shows an example of a graphical user interface 120 that includes a featured programming section 126 and an active area and sidebar section 129 that are displayed on the display 210 of the user devices 102-1 to 102-n under the control of the application or browser 206.

Video is displayed or played-back in the featured programming section 126. This allows the system to highlight television programs the users may be interested in such as season premiers (or finales), new television programs, highly rated television programs, or award winning programs, to list a few examples. The featured programming section 126 also displays video from suggested programs based on the viewing and recording habits of the users, in some examples.

A record button graphical icon 128 is provided to allow users to schedule a recording of the television program shown in the featured programming section 126. In the illustrated example, the record button 128 is located below the featured programming section. If the featured program is currently airing, then a watch now button graphical icon (not shown) is instead displayed. Upon selection by users, the watch now button sends a request to the cloud based video delivery systems 106 to begin streaming the featured program to the user devices. At the same time, a video portion for displaying the video content is presented in the GUI to display the content.

The illustrated embodiment further includes an active area 129 for displaying interactive menus or guides. In the illustrated embodiment, the active area 129 is a sidebar that includes user selectable tabs: a guide tab 130, a feed tab 132, a friends tab 134, a search tab 136, a settings tab 138, and an antenna status tab 140. In alternative embodiments, the active area 129 could include additional (or fewer) tabs. For example, there may be tabs for recently watched programs, a list of scheduled recordings, or a tab for submitting feedback.

In other examples, the tabs could be replaced with buttons, drop down menus, hyperlinks, or other user controllable active areas. In yet another example, the functionality of the tabs could be replaced by physical buttons of the user devices.

The guide tab 130, when selected by the users, causes the graphical user interface 120 to display a program guide 142, which displays a schedule of different television programs and broadcast networks. In the illustrated example, the program guide 142 also displays time information 141, date information 143, a program title 145, a broadcasting network 144, and a channel 146 (when available). Additionally, the program guide could also provide other information about the programs such as parental ratings or the length of the programs.

In the preferred embodiment, the program guide 142 is an interactive television schedule that is controlled by the users of the devices. That is, the users are able to access additional information about a television program and control what days, times and channels are displayed in the guide 142. Upon selection of television program 147, additional information about the program is displayed. Typically the information includes a synopsis of the television program, the names of actors/actresses in the program, and its parental rating, in some embodiments. Additionally, the users are also presented with a record button and a watch now button.

The selection of the record button schedules the television program to be recorded during its broadcast. The selection of the watch now button sends a request to the cloud based video delivery systems 106 to begin streaming the requested content to the users' device. At the same time, the program guide 142 returns to the active area 129 (or disappears) and video portion is displayed.

It will be appreciated by those skilled in the art that the program guide could be replaced by similar menus or interfaces in embodiments where the cloud based video delivery system does not stream live or pre-recorded over the air content. In these embodiments, the program guide could be replaced by other types of menus that perform similar functions. By way of example, if the cloud based video delivery system is streaming purchased content to user devices, then the program guide could be replaced with a menu or library or search interface, which displays the users' other purchased or available content.

The feed tab 132 provides a real time stream of news related to the television programs the users are currently watching or have scheduled to be recorded. The feed tab 132 generally includes information about when new episodes are airing, news about season premiers (or finales), time/dates of shows or marathons, and scores/highlights of recent sports games, to list a few examples.

The friends tab 134 shows a list of friends that are connected to the users. Connected users are able to communicate via live chat or send electronic messages to friends and family.

The search tab 136 enables users to search for programs based on program titles, broadcast networks, actor/actress names, genres, sports teams, times, dates, or general keywords (e.g., “police drama”).

The settings tab 138 enables users to customize settings of the graphical user interface 120. For example, users can choose to hide specific networks or shows, manage account information (e.g., username, password, contact information), manage billing information, or manage devices.

The antenna status tab 140 displays information about each user's assigned antenna element. For instance, the users are able to view how long they have been assigned an antenna element, a signal quality of their assigned antenna element, or which frequency (i.e., channel) the antenna element is tuned to receive.

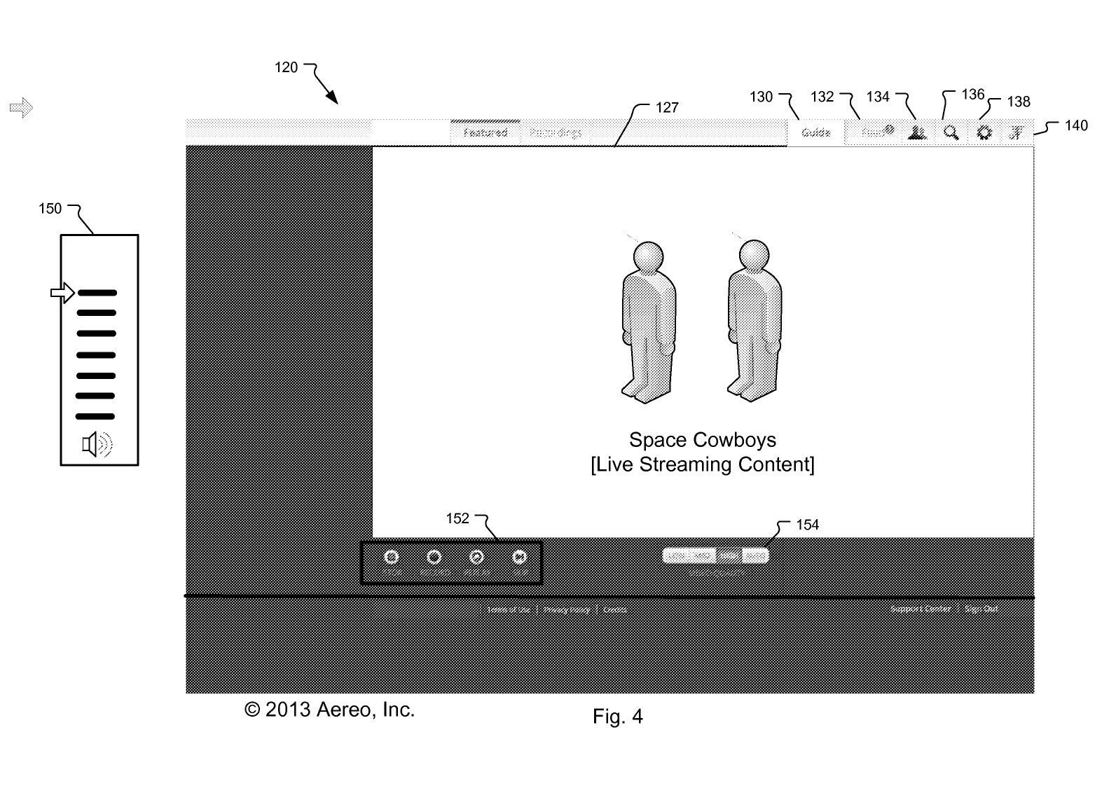

FIG. 4 illustrates an example of the graphical user interface 120, which includes a video portion 127 displaying streaming video content.

In a preferred embodiment, the size of the video portion 127 is based on several factors such as a physical display size of the devices, resolutions of the devices, and bandwidth (or network) capabilities. In a current embodiment, users are able to control the video quality or resolution of the streaming content (low, med, high, or auto) with video quality controls 154.

Playback controls 152 are displayed below the video portion 127 to allow users to control the playback of the streaming content via selection of graphical icons. A volume display 150 shows the volume of the streaming content in the video portion 127 of the graphical user interface 120. Generally, the users are able to adjust the volume of devices via controls in the graphical user interface or by physical buttons or slides.

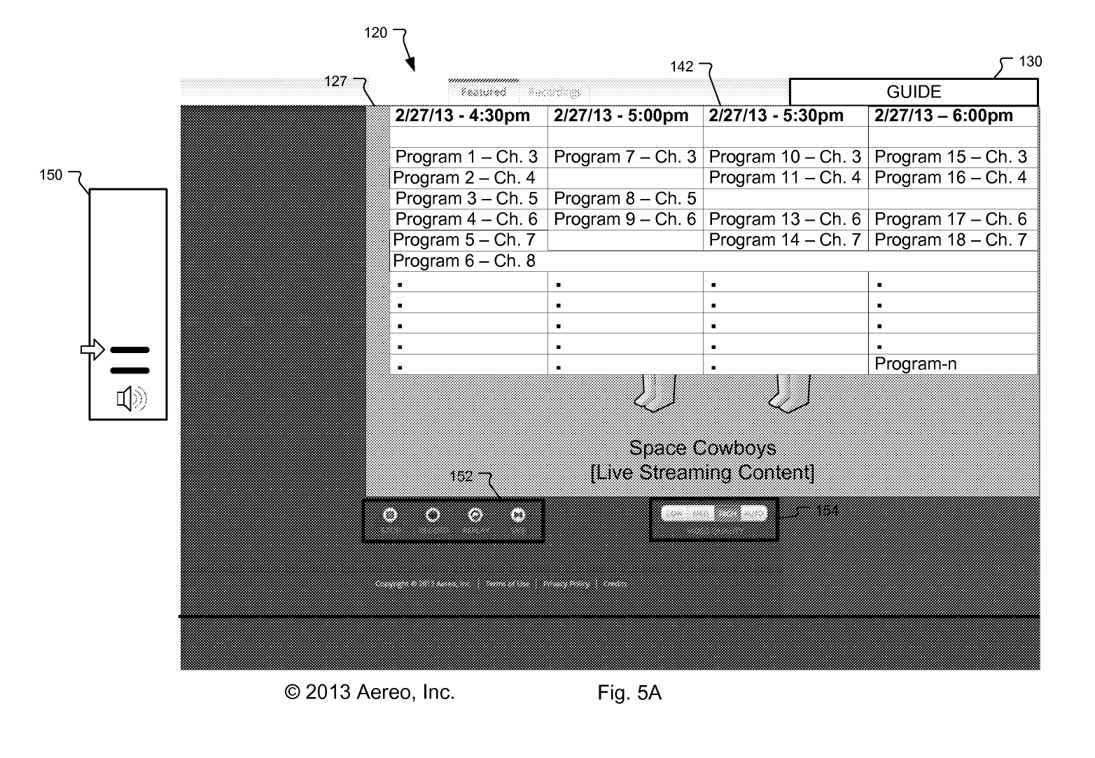

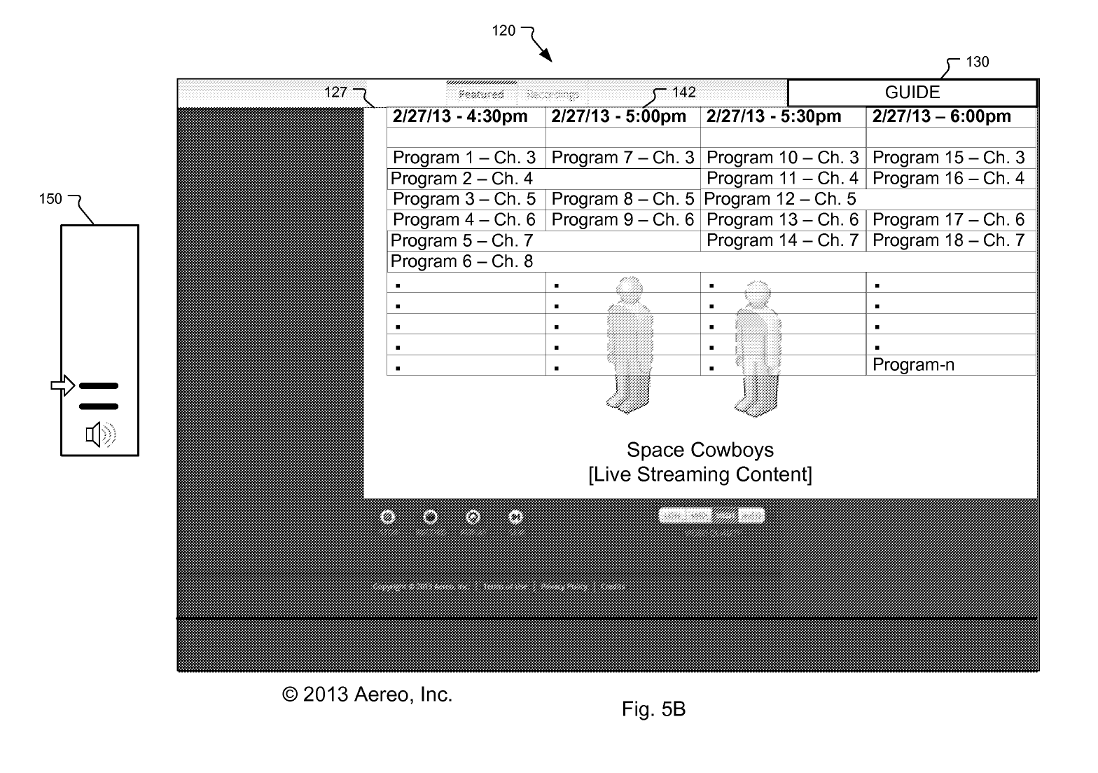

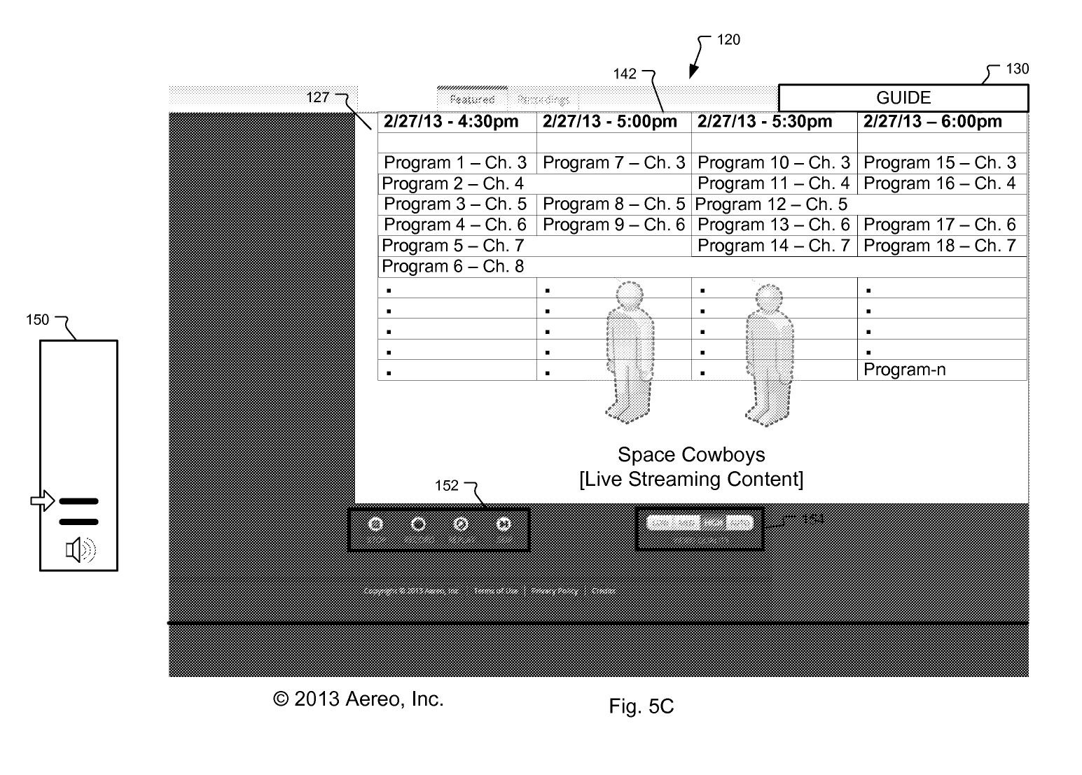

FIGS. 5A-5C illustrate different embodiments of how the program guide 142 is displayed in the graphical user interface 120 relative to the video portion 127 according to the principles of the invention.

In FIG. 5A, upon selection by the users of the guide active area or tab 130 during the playing of video, the program guide 142 expands to fill the display of the device and is overlaid over at least a portion of the video portion 127, in which the video, such as a television program or movie, is playing. In the preferred embodiment, the guide 142 covers a majority of the area of the video portion 127. The illustrated embodiment shows it covering more than 60% of the area of the video portion 127.

As previously described for FIG. 3, the program guide 142 is an interactive television schedule, which enables the users to access additional information about television programs by selecting television programs from the program guide. Similarly, the users are able to schedule recordings via a record now button graphical icon or begin watching a program immediately with a watch now button graphical icon (if the television program is currently airing).

Additionally, the users are also able to scroll through the program guide and view the television schedule at different times and dates and for different channels or networks. In one embodiment, horizontal and vertical scroll bars (not shown) are included to enable the users to control the scrolling of time, day, and channels. Typically, the horizontal scroll bar controls the day and time being viewed and the vertical scroll bar controls which television channels are being displayed. In embodiments, users scroll through the program guide with finger/hand gestures when the user devices are equipped with touchscreen interfaces or using a computer mouse.

In the illustrated embodiment the active area 130 of the interface 120 that is selected to invoke the program guide is shown as a tab. However, in examples, other types of active areas are used such as text-based hyperlinks, or graphical buttons on the interface. Or even physical buttons or keys on the device are used to invoke the guide 142.

In the preferred embodiment, the program guide 142 is opaque to prevent the streaming content in the video portion from distracting the uses while they read and interact with the program guide 142. To further reduce distractions, the video portion is grayed out and the volume of the streaming video is lowered by over 50% and in some examples is lowered by 80% (as shown in volume display 150). In general, graying out refers to reducing the color, contrast, brightness, and/or color saturation (or other color controls) to create a grayed out and less evident appearance in the video portion 127. In an alternative embodiment, the volume of the streaming content is muted rather than simply lowered.

In FIG. 5B, the program guide 142 is made partially transparent to allow users to still see the video portion 127 behind the overlaid program guide 142. In this embodiment, the video portion 127 is grayed out as well. In an alternative embodiment, the video portion 127 is not grayed-out. Instead, the transparency of the program guide 142 is used to reduce the brightness, contrast and color saturation of the video portion 127. Similar to the previous embodiment, the volume of the video playing in the video portion is preferably lowered or muted when the program guide 142 is displayed (as shown in volume control 150).

FIG. 5C shows another alternative embodiment in which the program guide 142 is made partially transparent and blurred. The blurring effect further reduces the visibility of the video portion 127 to prevent users for being distracted by the streaming content in the video portion 127. As in the previous embodiments, the volume 150 is preferably lowered or muted when the program guide 142 is displayed.

While FIGS. 5A-5C illustrate three different examples of how the program guide 142 could be displayed, alternative methods for displaying the program guide (or other menus) or reducing the visibility of the video portion could also be implemented. In one example, the program guide could expand to fill the entire display of the device rather than only partially covering the video portion. In another example, the streaming content could be paused (but continue buffering on the device) while the users search for new content. In this scenario, the users are not distracted by program because it is paused, but they also do not miss any part of the program since after the program guide is closed, the video is unpaused and then continues to playback. Moreover, there is no delay waiting for the program to buffer and start playing again.

In still another alternative embodiment, the users are able to configure the degree to which the video portion is grayed out, the transparency of the program guide, or how low the volume will be set when the program guide is displayed, to list a few examples.

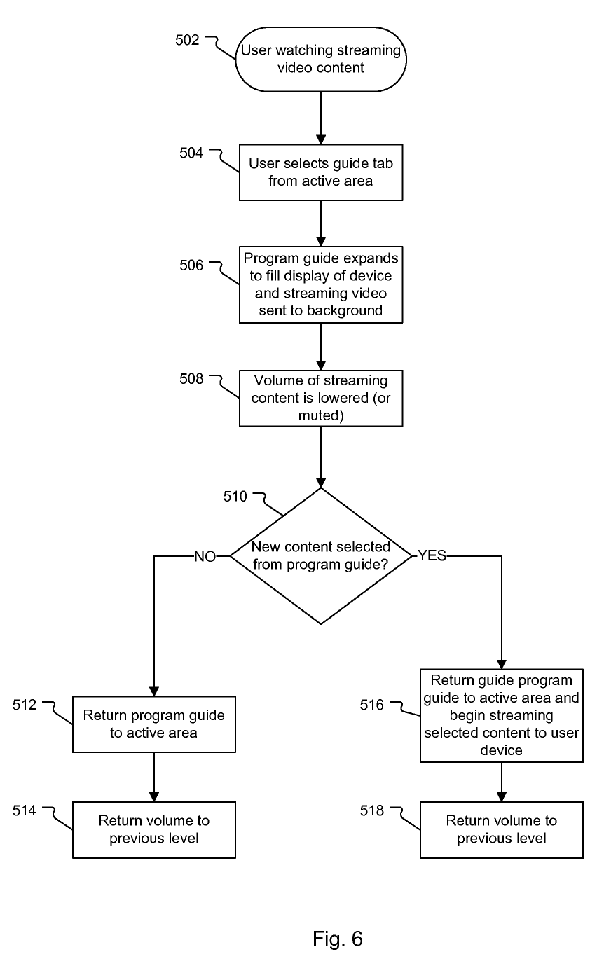

FIG. 6 is a flowchart illustrating the steps to display the program guide 142 and lower the volume of streaming content displayed in the video portion 127.

In the first step 502, a user is watching streaming video content on their user device. Next, the user selects the guide tab 130 from the active area 129 in step 504. In response to the selection of the guide tab 130, the program guide 142 expands to fill the majority of the display of the user device, and the video portion 127 is sent to background (and grayed out) in step 506. The volume of the streaming content in the video portion 127 is then lowered (or muted) in step 508.

In the next step 510, the GUI 120 determines if new content is selected by the user from the program guide 142. If new content is selected by the user, then the program guide 142 is returned to the active area 129 and a request is sent to the cloud based video delivery system 106 to begin streaming the selected content to the user device in step 516. Next, in step 518, the volume of video portion 127 is returned to previous level. If new content is not selected (e.g., the user exits the program guide), then the program guide 142 is returned to the active area 129 in step 512. Then, in step 514, the volume of the video content in the video portion is returned to previous levels.

While the steps of FIG. 6 have been directed toward displaying a program guide and selecting new television programs, similar steps would be performed when displaying other menus accessed from the active area.

While this invention has been particularly shown and described with references to preferred embodiments thereof, it will be understood by those skilled in the art that various changes in form and details may be made therein without departing from the scope of the invention encompassed by the appended claims.

What is claimed is:

1. A graphical user interface in a cloud based video delivery system comprising:
a video portion in which video content is displayed; and
a program guide overlay that is displayed over the video portion when invoked.

2. The graphical user interface of claim 1, further comprising an active area displayed adjacent to the video portion, wherein upon selection of the active area, the overlay is displayed over the video portion.

3. The graphical user interface of claim 1, wherein the video portion displays pre-recorded or live broadcast television programs.

4. The graphical user interface of claim 1, wherein when the program guide overlay is invoked, a volume of the video content is reduced.

5. The graphical user interface of claim 1, wherein when the program guide overlay is invoked, a volume of the video content is muted.

6. The graphical user interface of claim 1, wherein the overlay, which is displayed over the video portion, is partially transparent to allow viewing of the video content through the overlay.

7. The graphical user interface of claim 1, wherein the video content behind the overlay is grayed out when the overlay is invoked.

8. The graphical user interface of claim 1, wherein the video content is blurred when the overlay is invoked.

9. A method for displaying a program guide in a graphical user interface, the method comprising:
displaying video content in a video portion of the graphical user interface; and
in response to an invocation of the program guide, displaying a program guide overlay over the video portion of the graphical user interface.

10. The method according to claim 9, further comprising displaying an active area adjacent to the video portion, wherein upon selection of the active area, the overlay is displayed over the video portion.

11. The method according to claim 9, wherein the video portion displays pre-recorded or live broadcast television programs.

12. The method according to claim 9, further comprising lowering a volume of the video portion upon invocation of the program guide.

13. The method according to claim 9, further comprising muting a volume of the video portion upon invocation of the program guide.

14. The method according to claim 9, wherein the program guide overlay, which is displayed over the video portion, is partially transparent to allow viewing of the video content through the overlay.

15. The method according to claim 9, wherein the video content behind the overlay is grayed out when the overlay is invoked.

16. The method according to claim 9, wherein the video content is blurred when the overlay is invoked.
